(19) United States
(12) Patent Application Publication
(10) Pub. No.: US 2026/0228882 A1
(43) Pub. Date: Aug. 6, 2026

(54) WORK TIME CALCULATION METHOD AND WORK TIME CALCULATION SYSTEM

(71) Applicant: Kabushiki Kaisha Toshiba, Kawasaki-shi (JP)

(72) Inventors: Yukino MASUI, Yokohama Kanagawa (JP); Yojiro TONOUCHI, Inagi Tokyo (JP); Atsushi WADA, Hiki Saitama (JP); Tomoyuki SHIBATA, Kawasaki Kanagawa (JP); Yuya MITO, Yokohama Kanagawa (JP)

(21) Appl. No.: 19/454,848

(22) Filed: Jan. 21, 2026

(30) Foreign Application Priority Data
Jan. 27, 2025 (JP) 2025-011589

(51) Int. Cl. G06T 7/00; G06T 7/20

(52) U.S. Cl. CPC G06T 7/001; G06T 7/20; G06T 2207/20076; G06T 2207/30108

(57) ABSTRACT

A work time calculation method includes an acquisition process, a tracking process, and a calculation process. In the calculation process, a first calculation processing is performed when there is a second object corresponding to the first object among the second objects and when a number of the second objects corresponding to the first object is one. In the calculation process, a second calculation processing is performed when there is a second object corresponding to the first object among the second objects and when a number of the second objects corresponding to the first object is two or more. In the calculation process, when none of the second objects correspond to the first object, a third calculation processing is performed.

### CROSS-REFERENCE TO RELATED APPLICATIONS

This application is based upon and claims the benefit of priority from Japanese Patent Application No. 2025-011589, filed on January 27, 2025; the entire contents of which are incorporated herein by reference.

### FIELD

Embodiments described herein relate generally to a work time calculation method and a work time calculation system.

### BACKGROUND

There is a method of calculating a work time of each work process of a production line based on an image of the production line. In such a method, if an object being manufactured in the production line becomes hidden behind an obstacle such as a worker or the like, there are cases where the object can no longer be tracked; it is difficult to calculate the work time; and the work time can no longer be calculated with high accuracy.

### BRIEF DESCRIPTION OF THE DRAWINGS

FIG. 1 is a block diagram schematically illustrating a work time calculation system according to an embodiment.

FIG. 2 is an explanatory drawing illustrating an example of an image acquired by the camera of the work time calculation system according to the embodiment.

FIG. 3 is an explanatory drawing illustrating work times of the work time calculation system and the work time calculation method according to the embodiment.

FIG. 4 is an explanatory drawing illustrating a first calculation processing of the work time calculation system and the work time calculation method according to the embodiment.

FIG. 5 is an explanatory drawing illustrating the second calculation processing of the work time calculation system and the work time calculation method according to the embodiment.

FIG. 6 is an explanatory drawing illustrating the second calculation processing of the work time calculation system and the work time calculation method according to the embodiment.

FIG. 7 is an explanatory drawing illustrating the third calculation processing of the work time calculation system and the work time calculation method according to the embodiment.

FIG. 8 is an explanatory drawing illustrating the third calculation processing of the work time calculation system and the work time calculation method according to the embodiment.

FIG. 9 is a flowchart illustrating the work time calculation method according to the embodiment.

### DETAILED DESCRIPTION

A work time calculation method according to an embodiment includes an acquisition process, a tracking process, and a calculation process. The acquisition process includes acquiring an image of a production line including multiple work regions. The tracking process includes tracking, based on the image, an object manufactured in the production line. The calculation process includes calculating a work time in each of the multiple work regions based on a tracking result. The tracking process includes detecting a first time and a second time. The first time is a time at which a first object passed through a first gate positioned at an upstream end of one of the multiple work regions. The second time is a time at which a second object passed through a second gate positioned at a downstream end of the one of the multiple work regions. In the calculation process, a first calculation processing is performed when there is a second object corresponding to the first object among the second objects and when a number of the second objects corresponding to the first object is one. The first calculation processing includes calculating the work time based on a difference between the first time and the second time of the one of the second objects corresponding to the first object. In the calculation process, a second calculation processing is performed when there is a second object corresponding to the first object among the second objects and when a number of the second objects corresponding to the first object is two or more. The second calculation processing includes estimating one of the second objects corresponding to the first object, and calculating the work time based on a difference between the first time and the second time of the one of the second objects estimated to correspond to the first object. In the calculation process, when none of the second objects correspond to the first object, a third calculation processing is performed. The third calculation processing includes estimating the second time and calculating the work time based on a difference between the first time and the estimated second time.

Embodiments of the invention will now be described with reference to the drawings.

The drawings are schematic or conceptual; and the relationships between the thickness and width of portions, the proportions of sizes among portions, etc., are not necessarily the same as the actual values. The dimensions and proportions may be illustrated differently among drawings, even when the same portion is illustrated.

In the specification and drawings, components similar to those described previously or illustrated in an antecedent drawing are marked with the same reference numerals; and a detailed description is omitted as appropriate.

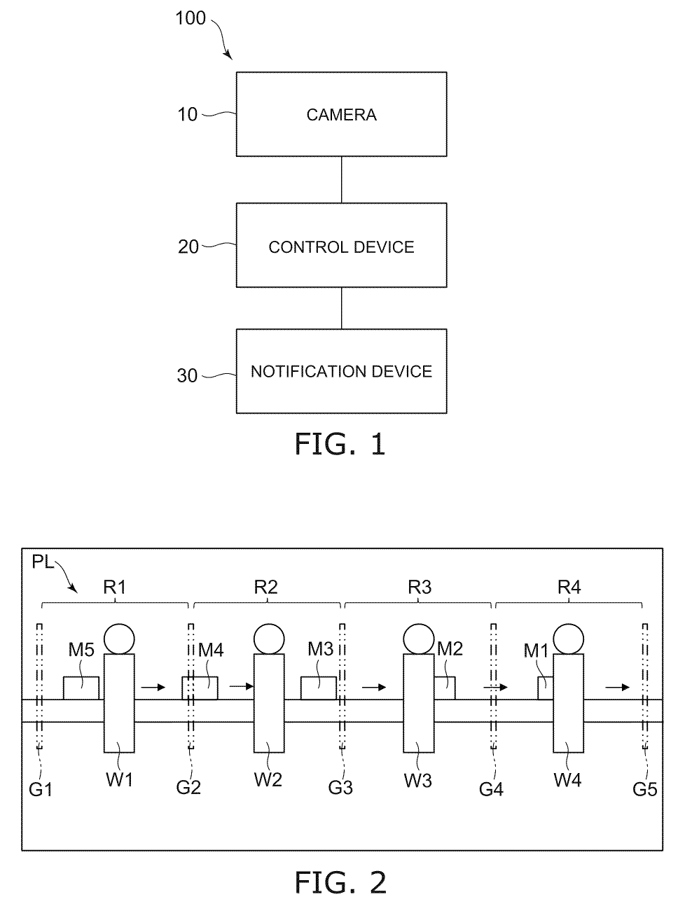

FIG. 1 is a block diagram schematically illustrating a work time calculation system according to an embodiment.

As illustrated in FIG. 1, the work time calculation system 100 according to the embodiment includes a camera 10, a control device 20, and a notification device 30. The work time calculation system 100 is configured to perform a work time calculation method described below.

The camera 10 acquires an image of a production line. The production line includes multiple work regions. The camera 10 is electrically connected to the control device 20. The camera 10 outputs the acquired image to the control device 20. The image may be a still image or a video image. The camera 10 includes, for example, a CCD (Charge-Coupled Device) image sensor or a CMOS (Complementary Metal-Oxide-Semiconductor) image sensor. For example, the camera 10 continuously acquires a video image and outputs the video image to the control device 20. For example, the camera 10 may acquire a still image for each prescribed period of time and output the still images to the control device 20. For example, the camera 10 may generate still images from a video image and output the still images to the control device 20. For example, the control device 20 may generate still images from a video image that is acquired.

The control device 20 is configured to perform various arithmetic processing of the work time calculation system 100 and the work time calculation method. The control device 20 includes, for example, a CPU (Central Processing Unit). For example, the control device 20 may be able to perform all of the arithmetic processing with one region, or may be divided into multiple regions that can perform each arithmetic processing.

Based on the image acquired by the camera 10, the control device 20 tracks an object manufactured in the production line. For example, the control device 20 assigns an ID to the object detected in the image and tracks the object to which the ID is assigned. For example, the control device 20 detects the object using object detection technology such as YOLOX or the like and tracks the object using object tracking technology such as ByteTrack or the like.

The control device 20 calculates the work time in each of the multiple work regions based on the tracking result. The control device 20 calculates the work time in the work region based on the difference between the time at which the object entered the work region and the time at which the object exited the work region. The control device 20 detects the time at which the object entered the work region and the time at which the object exited the work region by detecting the time at which the object passed through the gates partitioning the multiple work regions. The gates are, for example, virtual labels located on the image. For example, a gate is located in the production line between two mutually adjacent workers. The gate may be, for example, an actual label located on the production line. The calculation of the work time is described below.

The notification device 30 is configured to notify the work time output from the control device 20. The notification device 30 is electrically connected to the control device 20. For example, the notification device 30 may be a display or the like that visually notifies information with characters, drawings, etc., or may be a speaker that aurally notifies information by sound.

FIG. 2 is an explanatory drawing illustrating an example of an image acquired by the camera of the work time calculation system according to the embodiment.

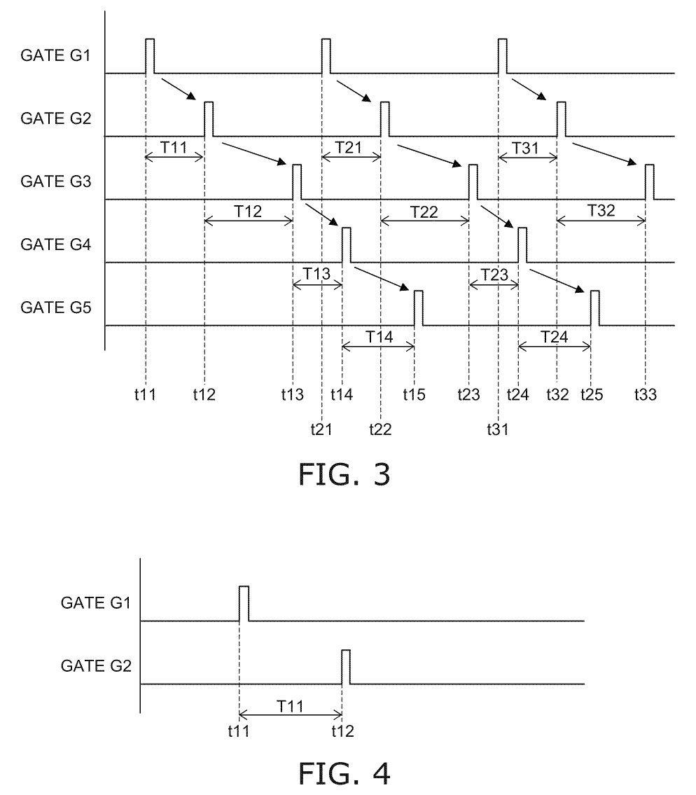

FIG. 3 is an explanatory drawing illustrating work times of the work time calculation system and the work time calculation method according to the embodiment.

In the example of FIG. 2, a production line PL includes the control device 20 detects the multiple work regions R1 to R4. The multiple work regions R1 to R4 are partitioned by multiple gates G1 to G5. The work region R1 is between the gate G1 and the gate G2; the work region R2 is between the gate G2 and the gate G3; the work region R3 is between the gate G3 and the gate G4; and the work region R4 is between the gate G4 and the gate G5. Workers W1 to W4 perform work respectively in the work regions R1 to R4. Objects M1 to M5 flow from the work region R1 side toward the work region R4 side. That is, in the work region R1, the gate G1 is positioned at the upstream end; and the gate G2 is positioned at the downstream end. In the work region R2, the gate G2 is positioned at the upstream end; and the gate G3 is positioned at the downstream end. In the work region R3, the gate G3 is positioned at the upstream end; and the gate G4 is positioned at the downstream end. In the work region R4, the gate G4 is positioned at the upstream end; and the gate G5 is positioned at the downstream end.

Based on the image, the control device 20 detects the times at which the object passed through the gates G1 to G5. In the example of FIG. 3, the control device 20 detects times t11, t21, and t31 at which the objects passed through the gate G1, times t12, t22, and t32 at which the objects passed through the gate G2, times t13, t23, and t33 at which the objects passed through the gate G3, times t14 and t24 at which the objects passed through the gate G4, and times t15 and t25 at which the objects passed through the gate G5.

In the example of FIG. 3, the object that passed through the gate G1 at the time t11 passed through the gate G2 at the time t12, passed through the gate G3 at the time t13, passed through the gate G4 at the time t14, and passed through the gate G5 at the time t15. The object that passed through the gate G1 at the time t21 passed through the gate G2 at the time t22, passed through the gate G3 at the time t23, passed through the gate G4 at the time t24, and passed through the gate G5 at the time t25. The object that passed through the gate G1 at the time t31 passed through the gate G2 at the time t32 and passed through the gate G3 at the time t33.

The control device 20 calculates that a duration T11, which is the difference between the time t11 and the time t12, a duration T21, which is the difference between the time t21 and the time t22, and a duration T31, which is the difference between the time t31 and the time t32, correspond to the work time of the work region R1. Similarly, the control device 20 calculates that a duration T12, which is the difference between the time t12 and the time t13, a duration T22, which is the difference between the time t22 and the time t23, and a duration T32, which is the difference between the time t32 and the time t33, correspond to the work time of the work region R2. Similarly, the control device 20 calculates that a duration T13, which is the difference between the time t13 and the time t14, and a duration T23, which is the difference between the time t23 and the time t24, correspond to the work time of the work region R3. Similarly, the control device 20 calculates that a duration T14, which is the difference between the time t14 and the time t15, and a duration T24, which is the difference between the time t24 and the time t25, correspond to the work time of the work region R4.

When there are no obstacles such as workers or the like in a work region (e.g., the work region R1) in the image, the control device 20 can continuously track an object that has passed through the gate (e.g., the gate G1) at the upstream end of the work region until the object passes through the gate (e.g., the gate G2) at the downstream end of the work region. Therefore, as described above, the control device 20 can calculate the work time based on the difference between the time at which the object passed through the gate (e.g., the gate G1) at the upstream end and the time at which the object passed through the gate (e.g., the gate G2) at the downstream end.

On the other hand, when there is an obstacle such as a worker (e.g., the worker W1) or the like in the work region (e.g., the work region R1) in the image, the object that passed through the gate (e.g., the gate G1) at the upstream end of the work region becomes hidden behind the obstacle, then appears from behind the obstacle, and then passes through the gate (e.g., the gate G2) at the downstream end of the work region. In such a case, the control device 20 cannot continuously track the object that passed through the gate (e.g., the gate G1) at the upstream end of the work region until the object passes through the gate (e.g., the gate G2) at the downstream end of the work region. It is therefore desirable to estimate whether or not the object that passed through the gate (e.g., the gate G1) at the upstream end has passed through the gate (e.g., the gate G2) at the downstream end.

Therefore, in the work time calculation system 100, the control device 20 detects an object that passed through the gate (e.g., the gate G1) at the upstream side and an object that passed through the gate (e.g., the gate G2) at the downstream side, and determines whether or not the object that passed through the gate (e.g., the gate G2) at the downstream side corresponds to the object that passed through the gate (e.g., the gate G1) at the upstream side. Then, the control device 20 calculates the work time based on the duration until the object that passed through the gate (e.g., the gate G1) at the upstream side passes through the corresponding gate (e.g., the gate G2) at the downstream side.

More specifically, the control device 20 detects a first time and a second time. The first time is the time at which a first object passed through a first gate. The second time is the time at which a second object passed through a second gate. The first gate is positioned at the upstream end of one of the multiple work regions. The second gate is positioned at the downstream end of the one of the multiple work regions. In the work regions R1 to R4, the gates G1 to G4 correspond respectively to the first gates; and the gates G2 to G5 correspond respectively to the second gates. An example will now be described in which the gate G1 corresponds to the first gate; and the gate G2 corresponds to the second gate. In other words, an example will now be described in which the work time of the work region R1 is calculated.

The control device 20 calculates the work time by performing one of the first to third calculation processing based on how many of the second objects correspond to the first object. For example, the control device 20 uses the object tracking technology described above to determine whether or not there is a second object corresponding to the first object. In the object tracking technology, the same ID is assigned to corresponding objects. That is, a state in which a second object corresponds to the first object is a state in which the ID of the second object and the ID of the first object are the same in the object tracking technology. A state in which a second object does not correspond to the first object is a state in which the ID of the second object and the ID of the first object are different in the object tracking technology. That is, a state in which one of the second objects corresponds to the first object is a state in which the one of the second objects has the same ID as the first object in the object tracking technology. A state in which two or more of the second objects correspond to the first object is a state in which the two or more of the second objects have the same ID as the first object in the object tracking technology. A state in which none of the second objects correspond to the first object is a state in which none of the second objects have the same ID as the first object in the object tracking technology. The first to third calculation processing will now be described.

FIG. 4 is an explanatory drawing illustrating a first calculation processing of the work time calculation system and the work time calculation method according to the embodiment.

In the example of FIG. 4, the first object passed through the gate G1 at the time t11 corresponding to the first time; and the second object that corresponds to the first object passed through the gate G2 at the time t12 corresponding to the second time.

Thus, the control device 20 performs the first calculation processing when there is a second object corresponding to the first object among the second objects and when the number of the second objects corresponding to the first object is one. In the first calculation processing, the control device 20 calculates the work time based on the difference between the first time and the second time of the one of the second objects corresponding to the first object. In the example of FIG. 4, the control device 20 calculates the work time (the duration T11) based on the difference between the time t11 and the time t12.

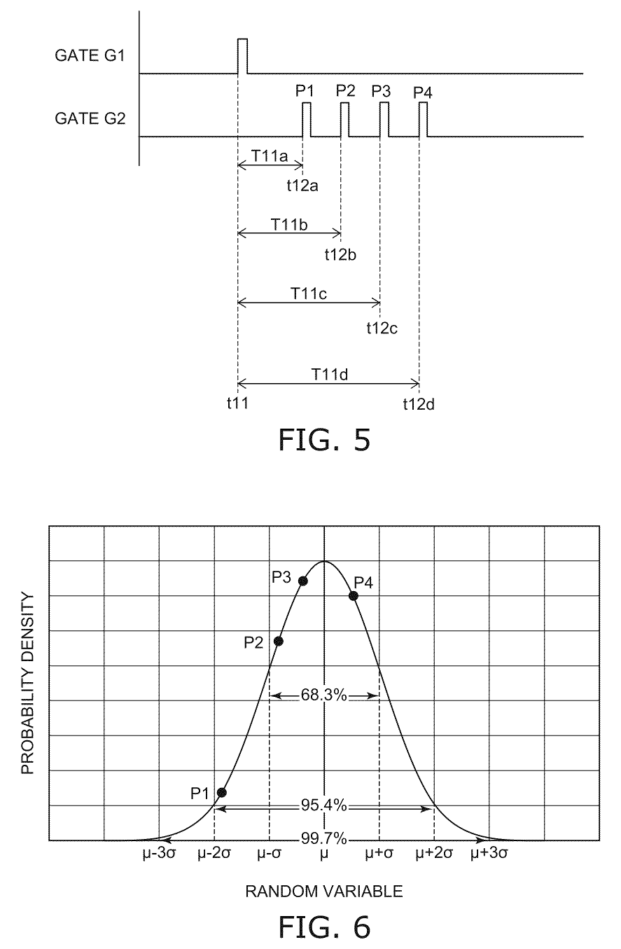

FIGS. 5 and 6 are explanatory drawings illustrating the second calculation processing of the work time calculation system and the work time calculation method according to the embodiment.

In the example of FIGS. 5 and 6, the first object passed through the gate G1 at the time t11 corresponding to the first time; and second objects that correspond to the first object passed through the gate G2 at a time t12a, a time t12b, a time t12c, and a time t12d corresponding to the second time. That is, in the example of FIGS. 5 and 6, four of the second objects correspond to the first object.

Hereinbelow, the second object that passed through the gate G2 at the time t12a is referred to as a second object P1; the second object that passed through the gate G2 at the time t12b is referred to as a second object P2; the second object that passed through the gate G2 at the time t12c is referred to as a second object P3; and the second object that passed through the gate G2 at the time t12d is referred to as a second object P4. When the second object P1 is one of the second objects corresponding to the first object, the control device 20 calculates the work time (a duration T11a) based on the difference between the time t11 and the time t12a. When the second object P2 is one of the second objects corresponding to the first object, the control device 20 calculates the work time (a duration T11b) based on the difference between the time t11 and the time t12b. When the second object P3 is one of the second objects corresponding to the first object, the control device 20 calculates the work time (a duration T11c) based on the difference between the time t11 and the time t12c. When the second object P4 is one of the second objects corresponding to the first object, the control device 20 calculates the work time (a duration T11d) based on the difference between the time t11 and the time t12d.

Thus, the control device 20 performs the second calculation processing when there is a second object corresponding to the first object among the second objects and when the number of the second objects corresponding to the first object is two or more. In the second calculation processing, first, the control device 20 estimates one of the second objects corresponding to the first object among the multiple second objects corresponding to the first object. For example, the calculation of a probability density using a probability distribution is used to estimate one of the second objects corresponding to the first object. The estimation of the one of the second objects corresponding to the first object by using a probability distribution to calculate a probability density will now be described.

For example, as illustrated in FIG. 6, the control device 20 determines a probability distribution of the duration (the movement time) for the object to move from the first gate (the gate G1) to the second gate (the gate G2) based on previous actual results. Then, the control device 20 estimates the second object of which the difference between the first time and the second time has the highest probability value in the probability distribution to be the one of the second objects corresponding to the first object. In the example of FIG. 6 the second object of which the difference between the first time and the second time has the highest probability value in the probability distribution is the second object P3. That is, the probability that the movement time is the duration T11c is greater than the probability that the movement time is the duration T11a, greater than the probability that the movement time is the duration T11b, and greater than the probability that the movement time is the duration T11c. Accordingly, the control device 20 estimates the second object P3 to be the one of the second objects corresponding to the first object.

The control device 20 then calculates the work time based on the difference between the first time and the second time of the one of the second objects estimated to correspond to the first object. In the example of FIGS. 5 and 6, the control device 20 calculates the work time (the duration T11c) based on the difference between the time t11 and the time t12c.

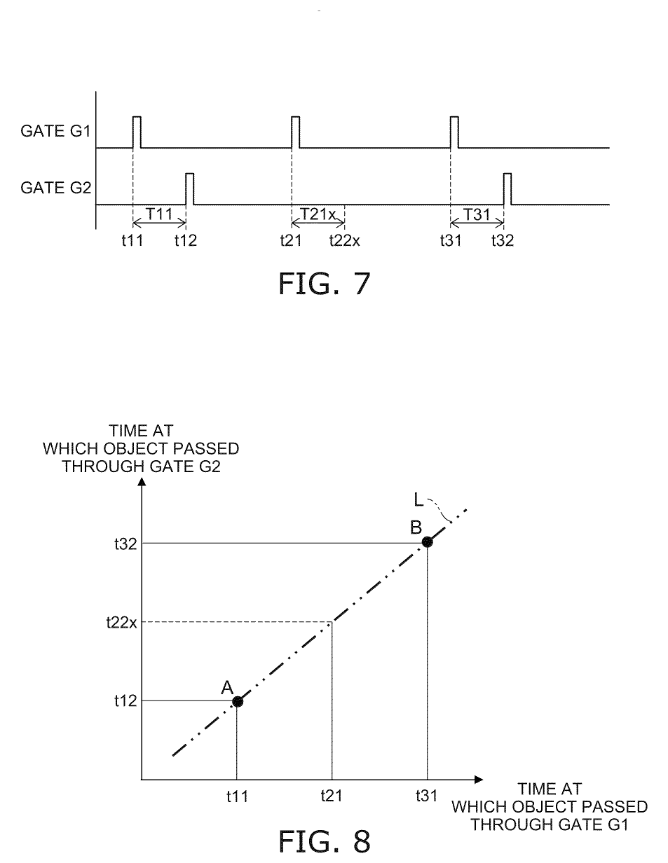

FIGS. 7 and 8 are explanatory drawings illustrating the third calculation processing of the work time calculation system and the work time calculation method according to the embodiment.

In the example of FIGS. 7 and 8, the object (the second object) that passed through the gate G2 at the time t12 corresponds to the object (the first object) that passed through the gate G1 at the time t11. Also, the object (the second object) that passed through the gate G2 at the time t32 corresponds to the object (the first object) that passed through the gate G1 at the time t31. However, no second object that corresponds to the object (the first object) that passed through the gate G1 at the time t21 is detected. That is, in the example of FIGS. 7 and 8, it is unknown when the object (the first object) that passed through the gate G1 at the time t21 passed through the gate G2 (i.e., the second time is unknown).

Thus, when none of the second objects correspond to the first object, the control device 20 performs the third calculation processing. In the third calculation processing, first, the control device 20 estimates the second time. For example, DP (Dynamic Programming) matching is used to estimate the second time. Estimation of the second time by using DP matching will now be described.

For example, as illustrated in FIG. 8, the control device 20 determines a first preceding passage time, a second preceding passage time, a first succeeding passage time, and a second succeeding passage time. The first preceding passage time is the time of passing through the first gate of the preceding object that passed through the first gate before the first object. The second preceding passage time is the time at which the preceding object passed through the second gate. In the example of FIG. 8, the object that passed through the gate G1 at the time t11 and passed through the gate G2 at the time t12 corresponds to the preceding object. That is, in the example of FIG. 8, the time t11 corresponds to the first preceding passage time; and the time t12 corresponds to the second preceding passage time. The first succeeding passage time is the time of passing through the first gate of the succeeding object that passed through the first gate after the first object. The second succeeding passage time is the time at which the succeeding object passed through the second gate. In the example of FIG. 8, the object that passed through the gate G1 at the time t31 and passed through the gate G2 at the time t32 corresponds to the succeeding object. That is, in the example of FIG. 8, the time t31 corresponds to the first succeeding passage time; and the time t32 corresponds to the second succeeding passage time.

Then, as illustrated in FIG. 8, the control device 20 determines a straight-line approximation based on the first preceding passage time, the second preceding passage time, the first succeeding passage time, and the second succeeding passage time. In FIG. 8, a straight line L that connects point A corresponding to the passage times (the time t11 and the time t12) of the preceding object and point B corresponding to the passage times (the time t31 and the time t32) of the succeeding object in a graph having the times at which the object passed through the gate G1 on the horizontal axis and the times at which the object passed through the gate G2 on the vertical axis corresponds to the straight-line approximation.

Then, as illustrated in FIG. 8, the control device 20 estimates the time corresponding to the first time on the straight- line approximation to be the second time. In the example of FIG. 8, a time t22x that corresponds to a time t21 on the straight-line L is estimated to be the second time.

Although the straight-line approximation is determined based on the passage times of one preceding object and the passage times of one succeeding object in the example of FIG. 8, the determination may be performed based on the passage times of multiple preceding objects and the passage times of one succeeding object, based on the passage times of one preceding object and the passage times of multiple succeeding objects, or based on the passage times of multiple preceding objects and the passage times of multiple succeeding objects.

The straight-line approximation may be determined based on the passage times of multiple preceding objects. For example, when the time t32 is estimated to correspond to the second time, the straight-line approximation may be determined based on the passage times (the time t11 and the time t12) of a first preceding object and the passage times (the time t21 and the time t22) of a second preceding object. The straight-line approximation may be determined based on the passage times of multiple succeeding objects. For example, when the time t12 is estimated to correspond to the second time, the straight-line approximation may be determined based on the passage times (the time t21 and the time t22) of a first succeeding object and the passage times (the time t31 and the time t32) of a second succeeding object.

The control device 20 then calculates the work time based on the difference between the first time and the estimated second time. In the example of FIGS. 7 and 8, the control device 20 calculates the work time (a duration T21x) based on the difference between the time t21 and the time t22x.

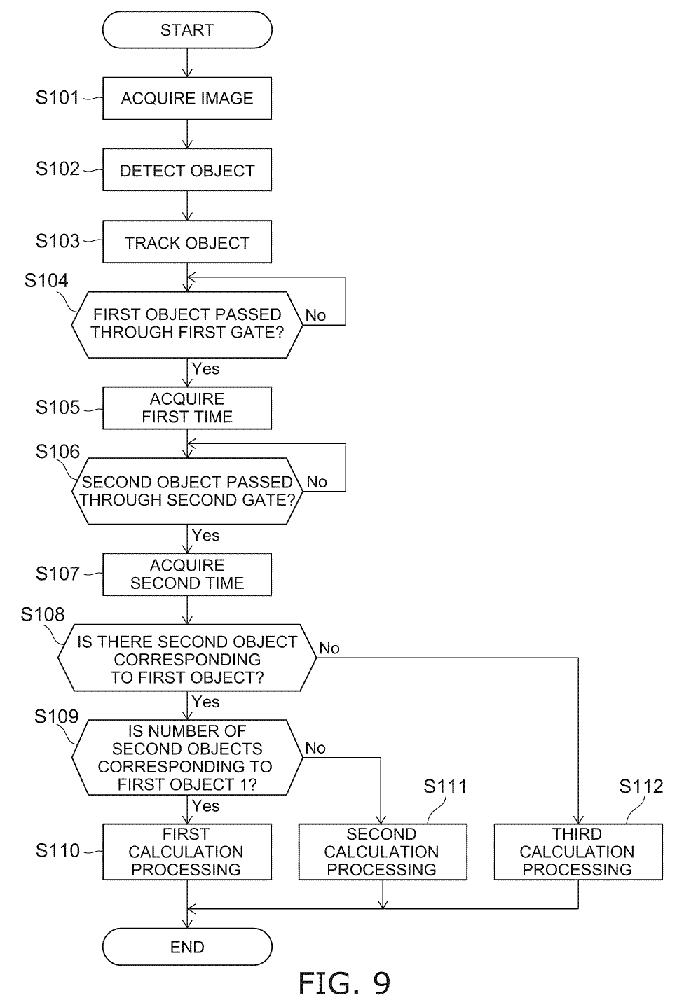

FIG. 9 is a flowchart illustrating the work time calculation method according to the embodiment.

As illustrated in FIG. 9, the work time calculation method according to the embodiment includes steps S101 to S112. Step S101 corresponds to the acquisition process. Steps S102 to S107 correspond to the tracking process. Steps S108 to S112 correspond to the calculation process.

First, the control device 20 acquires an image of a production line (step S101). The camera 10 acquires the image.

The control device 20 then detects an object manufactured in the production line based on the image (step S102) and tracks the object (step S103). At this time, for example, the control device 20 assigns an ID to the object detected in the image and tracks the object to which the ID is assigned. For example, the control device 20 detects the object using the object detection technology described above and tracks the object using the object tracking technology described above. When starting the tracking, the control device 20 detects the first time and the second time. The first time is the time at which the first object passed through the first gate. The second time is the time at which the second object passed through the second gate.

More specifically, first, the control device 20 determines whether or not the first object has passed through the first gate (step S104). When the first object has not passed through the first gate (step S104: No), the control device 20 repeats step S104 until the first object has passed through the first gate. When the first object has passed through the first gate (step S104: Yes), the control device 20 acquires the first time (step S105).

The control device 20 then determines whether or not the second object has passed through the second gate (step S106). When the second object has not passed through the second gate (step S106: No), the control device 20 repeats step S106 until the second object has passed through the second gate. When the second object has passed through the second gate (step S106: Yes), the control device 20 acquires the second time (step S107).

The control device 20 then calculates the work time in each of the multiple work regions based on the tracking result. More specifically, first, the control device 20 determines whether or not there is a second object corresponding to the first object among the second objects (step S108). When there is a second object corresponding to the first object (step S108: Yes), the control device 20 determines whether or not the number of the second objects corresponding to the first object is one (step S109).

When the number of the second objects corresponding to the first object is one (step S109: Yes), the control device 20 performs the first calculation processing (step S110). In the first calculation processing, the control device 20 calculates the work time based on the difference between the first time and the second time of the one of the second objects corresponding to the first object. The calculation of the work time in the first calculation processing is as described above.

When the number of the second objects corresponding to the first object is multiple (step S109: No), the control device 20 performs the second calculation processing (step S111). In the second calculation processing, first, the control device 20 estimates one of the second objects corresponding to the first object. The control device 20 then calculates the work time based on the difference between the first time and the second time of the one of the second objects estimated to correspond to the first object. The second calculation processing is as described above.

When none of the second objects correspond to the first object (step S108: No), the control device 20 performs the third calculation processing (step S112). In the third calculation processing, first, the control device 20 estimates the second time. The control device 20 then calculates the work time based on the difference between the first time and the estimated second time. The third calculation processing is as described above.

In other words, in the work time calculation method according to the embodiment, the control device 20 performs the first calculation processing when, in the determination process, there is a second object corresponding to the first object among the second objects and when the number of the second objects corresponding to the first object is one. The control device 20 performs the second calculation processing when, in the determination process, there is a second object corresponding to the first object among the second objects and when the number of the second objects corresponding to the first object is two or more. The control device 20 performs the third calculation processing when none of the second objects correspond to the first object in the determination process.

Effects of the work time calculation method and the work time calculation system according to the embodiments will now be described.

There is a method of calculating a work time of each work process of a production line based on an image of the production line. In such a method, if an object being manufactured in the production line becomes hidden behind an obstacle such as a worker or the like, there are cases where the object can no longer be tracked; it is difficult to calculate the work time; and the work time can no longer be calculated with high accuracy.

In contrast, in the work time calculation method and the work time calculation system according to the embodiments, the work time can be calculated with high accuracy by performing the first calculation processing when there is a second object corresponding to the first object and when the number of the second objects corresponding to the first object is one, by performing the second calculation processing when there is a second object corresponding to the first object and when the number of the second objects corresponding to the first object is two or more, and by performing the third calculation processing when none of the second objects correspond to the first object.

In the work time calculation method and the work time calculation system according to the embodiments, in the second calculation processing, one of the second objects that corresponds to the first object can be estimated, even when the number of the second objects corresponding to the first object is two or more, by determining the probability distribution of the time for the object to move from the first gate to the second gate based on previous actual results, and by estimating the second object of which the difference between the first time and the second time has the highest probability value in the probability distribution to be the one of the second objects corresponding to the first object. As a result, the work time can be calculated with high accuracy.

In the work time calculation method and the work time calculation system according to the embodiments, in the third calculation processing, the second time can be estimated, even when none of the second objects correspond to the first object, by determining a straight-line approximation based on the first preceding passage time, the second preceding passage time, the first succeeding passage time, and the second succeeding passage time, and by estimating the time corresponding to the first time on the straight-line approximation to be the second time. As a result, the work time can be calculated with high accuracy.

In the work time calculation method and the work time calculation system according to the embodiments, in the tracking process, the object can be more reliably tracked by assigning an ID to the object detected in the image and by tracking the object to which the ID is assigned. As a result, the work time can be calculated with high accuracy.

In the work time calculation method and the work time calculation system according to the embodiments, by notifying the work time, an evaluation of the line balance and the like based on the work time can be performed. The line balance can be improved thereby.

Embodiments may include the following configurations.

### Configuration 1

A work time calculation method, comprising:

an acquisition process of acquiring an image of a production line including a plurality of work regions;

a tracking process of tracking an object based on the image, the object being manufactured in the production line; and

a calculation process of calculating a work time in each of the plurality of work regions based on a tracking result,

the tracking process detecting a first time at which a first object passed through a first gate positioned at an upstream end of one of the pluralities of work regions, and a second time at which a second object passed through a second gate positioned at a downstream end of the one of the pluralities of work regions,

in the calculation process, when there is a second object corresponding to the first object among the second objects and when a number of the second objects corresponding to the first object is one, a first calculation processing being performed to calculate the work time based on a difference between the first time and the second time of the one of the second objects corresponding to the first object,

in the calculation process, when there is a second object corresponding to the first object among the second objects and when a number of the second objects corresponding to the first object is two or more, a second calculation processing being performed to estimate one of the second objects corresponding to the first object, and

calculate the work time based on a difference between the first time and the second time of the one of the second objects estimated to correspond to the first object,

in the calculation process, when none of the second objects correspond to the first object, a third calculation processing being performed to estimate the second time, and

calculate the work time based on a difference

between the first time and the estimated second time.

### Configuration 2

The work time calculation method according to configuration 1, wherein the second calculation processing includes estimating one of the second objects corresponding to the first object by:

determining, based on previous actual results, a probability distribution of time for the object to move from the first gate to the second gate; and

estimating the second object of which the difference between the first time and the second time has a highest probability value in the probability distribution to be the one of the second objects corresponding to the first object.

### Configuration 3

The work time calculation method according to configuration 1 or 2, wherein the third calculation processing includes estimating the second time by:

determining a straight-line approximation based on a first preceding passage time at which a preceding object passed through the first gate before the first object, a second preceding passage time at which the preceding object passed through the second gate, a first succeeding passage time at which a succeeding object passed through the first gate after the first object, and a second succeeding passage time at which the succeeding object passed through the second gate; and

estimating a time on the straight-line approximation corresponding to the first time to be the second time.

### Configuration 4

The work time calculation method according to any one of configurations 1 to 3, wherein the tracking process includes assigning an ID to the object detected in the image, and tracking the object to which the ID is assigned.

### Configuration 5

The work time calculation method according to any one of configurations 1 to 4, further comprising:

a notification process of notifying the work time.

### Configuration 6

A work time calculation system, comprising:

a camera configured to acquire an image of a production line including a plurality of work regions; and

a control device configured to track an object based on the image, and calculate a work time in each of the plurality of work regions based on a tracking result,

the object being manufactured in the production line,

the control device being configured to detect a first time at which a first object passed through a first gate positioned at an upstream end of one of the pluralities of work regions, and a second time at which a second object passed through a second gate positioned at a downstream end of the one of the pluralities of work regions,

the control device being configured to when there is a second object corresponding to the first object among the second objects and when a number of the second objects corresponding to the first object is one, perform a first calculation processing of calculating the work time based on a difference between the first time and the second time of the one of the second objects corresponding to the first object,

when there is a second object corresponding to the first object among the second objects and when a number of the second objects corresponding to the first object is two or more, perform a second calculation processing of estimating one of the second objects corresponding to the first object, and

calculating the work time based on a difference between the first time and the second time of the one of the second objects estimated to correspond to the first object, and

when none of the second objects correspond to the first object, perform a third calculation processing of estimating the second time, and

calculating the work time based on a difference between the first time and the estimated second time.

### Configuration 7

The work time calculation system according to configuration 6, wherein the control device, in the second calculation processing, estimates the one of the second objects corresponding to the first object by:

determining, based on previous actual results, a probability distribution of a movement time for the object to move from the first gate to the second gate; and

estimating the second object of which the difference between the first time and the second time has the highest probability value in the probability distribution to be the one of the second objects corresponding to the first object.

### Configuration 8

The work time calculation system according to configuration 6 or 7, wherein the control device, in the third calculation processing, estimates the second time by:

determining a straight-line approximation based on a first preceding passage time at which a preceding object passed through the first gate before the first object, a second preceding passage time at which the preceding object passed through the second gate, a first succeeding passage time at which a succeeding object passed through the first gate after the first object, and a second succeeding passage time at which the succeeding object passed through the second gate; and

estimating a time on the straight-line approximation corresponding to the first time to be the second time.

### Configuration 9

The work time calculation system according to any one of configurations 6 to 8, wherein the control device assigns an ID to the object detected in the image and tracks the object to which the ID is assigned.

### Configuration 10

The work time calculation system according to any one of configurations 6 to 9, further comprising:

a notification device configured to notify the work time.

Thus, according to embodiments, a work time calculation method and a work time calculation system can be provided in which the work time can be calculated easily, even when an object becomes hidden behind a worker.

While certain embodiments have been described, these embodiments have been presented by way of example only and are not intended to limit the scope of the inventions. Indeed, the novel embodiments described herein may be embodied in a variety of other forms; furthermore, various omissions, substitutions, and changes in the form of the embodiments herein may be made without departing from the spirit of the inventions. The accompanying claims and their equivalents are intended to cover such forms or modifications as would fall within the scope and spirit of the inventions.

What is claimed is:

1. A work time calculation method, comprising:
an acquisition process of acquiring an image of a production line including a plurality of work regions;
a tracking process of tracking an object based on the image, the object being manufactured in the production line; and
a calculation process of calculating a work time in each of the plurality of work regions based on a tracking result,
the tracking process detecting a first time at which a first object passed through a first gate positioned at an upstream end of one of the pluralities of work regions, and a second time at which a second object passed through a second gate positioned at a downstream end of the one of the pluralities of work regions,
in the calculation process, when there is a second object corresponding to the first object among the second objects and when a number of the second objects corresponding to the first object is one, a first calculation processing being performed to calculate the work time based on a difference between the first time and the second time of the one of the second objects corresponding to the first object,
in the calculation process, when there is a second object corresponding to the first object among the second objects and when a number of the second objects corresponding to the first object is two or more, a second calculation processing being performed to estimate one of the second objects corresponding to the first object, and calculate the work time based on a difference between the first time and the second time of the one of the second objects estimated to correspond to the first object,
in the calculation process, when none of the second objects correspond to the first object, a third calculation processing being performed to estimate the second time and calculate the work time based on a difference between the first time and the estimated second time.

2. The work time calculation method according to claim 1, wherein the second calculation processing includes estimating one of the second objects corresponding to the first object by:
determining, based on previous actual results, a probability distribution of time for the object to move from the first gate to the second gate;
and estimating the second object of which the difference between the first time and the second time has a highest probability value in the probability distribution to be the one of the second objects corresponding to the first object.

3. The work time calculation method according to claim 1, wherein the third calculation processing includes estimating the second time by:
determining a straight-line approximation based on a first preceding passage time at which a preceding object passed through the first gate before the first object, a second preceding passage time at which the preceding object passed through the second gate, a first succeeding passage time at which a succeeding object passed through the first gate after the first object, and a second succeeding passage time at which the succeeding object passed through the second gate;
and estimating a time on the straight-line approximation corresponding to the first time to be the second time.

4. The work time calculation method according to claim 1, wherein the tracking process includes assigning an ID to the object detected in the image, and tracking the object to which the ID is assigned.

5. The work time calculation method according to claim 1, further comprising:
a notification process of notifying the work time.

6. A work time calculation system, comprising:
a camera configured to acquire an image of a production line including a plurality of work regions; and
a control device configured to track an object based on the image, and calculate a work time in each of the plurality of work regions based on a tracking result, the object being manufactured in the production line,
the control device being configured to detect a first time at which a first object passed through a first gate positioned at an upstream end of one of the plurality of work regions, and a second time at which a second object passed through a second gate positioned at a downstream end of the one of the plurality of work regions,
the control device being configured to when there is a second object corresponding to the first object among the second objects and when a number of the second objects corresponding to the first object is one, perform a first calculation processing of calculating the work time based on a difference between the first time and the second time of the one of the second objects corresponding to the first object,
when there is a second object corresponding to the first object among the second objects and when a number of the second objects corresponding to the first object is two or more, perform a second calculation processing of estimating one of the second objects corresponding to the first object, and calculating the work time based on a difference between the first time and the second time of the one of the second objects estimated to correspond to the first object, and
when none of the second objects correspond to the first object, perform a third calculation processing of estimating the second time and calculating the work time based on a difference between the first time and the estimated second time.

7. The work time calculation system according to claim 6, wherein the control device, in the second calculation processing, estimates the one of the second objects corresponding to the first object by:
determining, based on previous actual results, a probability distribution of a movement time for the object to move from the first gate to the second gate; and
estimating the second object of which the difference between the first time and the second time has a highest probability value in the probability distribution to be the one of the second objects corresponding to the first object.

8. The work time calculation system according to claim 6, wherein the control device, in the third calculation processing, estimates the second time by:
determining a straight-line approximation based on a first preceding passage time at which a preceding object passed through the first gate before the first object, a second preceding passage time at which the preceding object passed through the second gate, a first succeeding passage time at which a succeeding object passed through the first gate after the first object, and a second succeeding passage time at which the succeeding object passed through the second gate; and
estimating a time on the straight-line approximation corresponding to the first time to be the second time.

9. The work time calculation system according to claim 6, wherein the control device assigns an ID to the object detected in the image and tracks the object to which the ID is assigned.

10. The work time calculation system according to claim 6, further comprising:
a notification device configured to notify the work time.
